(19) United States
(12) Patent Application Publication
(10) Pub. No.: US 2026/0238852 A1
(43) Pub. Date: Aug. 13, 2026

(54) Detecting Content Receipt and Presentation, as a Trigger for Attention Monitoring and/or Other Action

(71) Applicant: The Nielsen Company (US), LLC, New York, NY (US)

(72) Inventors: Pararth Sanjiv Mehta, Mckinney, TX (US); Achilleas Papakostas, Dallas, TX (US); Pankaj Bengani, Mumbai (IN); Akshay Padmakar Sakare, Mumbai (IN)

(21) Appl. No.: 19/352,214

(22) Filed: Oct. 7, 2025

(30) Foreign Application Priority Data
Feb. 11, 2025 (GR) 20250100117

(51) Int. Cl. H04N 21/442; H04N 21/24

(52) U.S. Cl. CPC H04N 21/44218; H04N 21/2407

(57) ABSTRACT

Methods and systems for invoking an attention-monitoring process as to media content presented by a media-presentation device. A computing system may detect, based on evaluation of packet-data communication with the media-presentation device, that the media-presentation device is receiving media content of a particular type, such as an advertisement, and the computing system may responsively invoke the attention-monitoring process. Alternatively or additionally, the computing system may detect based on information from an accessibility service in the media-presentation device, that the media-presentation device is presenting media content of a particular type, such as an advertisement, and the computing system may responsively invoke the attention-monitoring process.

### REFERENCE TO RELATED APPLICATION

This application claims priority to Greek Patent Application No. 20250100117, filed February 11, 2025.

### SUMMARY

In order to measure the extent to which people of various demographics are exposed to visual media content, including but not limited to content presented by media-presentation devices such as televisions, streaming-media players, set top boxes, computers, tablets, smartphones, gaming devices, and others, an audience-measurement company may arrange to have people report time periods when they are viewing such content and/or may arrange to have media-monitoring devices or “meters” monitor time periods when such content is presented and when particular people are viewing the content. The audience-measurement company may then establish associated media-exposure data correlated with pre-stored demographics and may use the data as a basis to establish ratings statistics that may facilitate commercial processes such as ad placement or other content delivery. People may opt in to this and/or other monitoring of media-content presentation, and to monitoring of their exposure to the presented media content.

Engaging in this sort of monitoring process may not only facilitate measuring an extent to which particular media content was presented, but may also usefully facilitate taking action in real-time while the media content is being presented.

By way of example, if a meter could determine that a device is currently presenting a particular type of media content, that determination could be used in real-time as a basis to automatically trigger an action such as monitoring whether a person is actually viewing, listening to, or otherwise being attentive to the presented media content. For instance, if a meter could determine that a device is currently presenting an advertisement (e.g., a form of communication designed to promote a product, service, brand, event, or the like) rather than, say, a program or other non-advertisement content, that determination could be used in real-time as a basis to trigger an attention-monitoring process that monitors whether a person is looking at a display of the device, and thus at the presentation of the advertisement.

Accordingly, the present disclosure provides mechanisms for detecting when a device is presenting an advertisement, and for responsively triggering in real-time an attention-monitoring process. One disclosed mechanism involves having a meter that is within a packet-data communication path of the device (i) detect, based on an evaluation of packet-data communicated along that path, that an advertisement is being communicated to the device, which suggests presentation of the advertisement by the device, and (ii) responsively trigger the attention-monitoring process. Another disclosed mechanism involves having the device itself (i) detect, based on information from an accessibility service in the device, that the device is presenting an advertisement, and (ii) responsively trigger the attention-monitoring process.

Further, these mechanisms could be broadened out as well to involve detecting that the device is presenting any particular type of content, not limited to an advertisement, as a basis to trigger attention monitoring. Still further, the mechanisms could be broadened out as well to involve responsively triggering any of a variety of actions, not limited to an attention-monitoring process. Without limitation, other example actions may include changing the audio output volume of the content presentation and/or revising the content presentation (e.g., replacing an advertisement or other segment of the content, or adding an overlay to the content), among other possibilities.

Thus, in one respect, disclosed is a method for triggering an attention-monitoring process. This method involves a computing system that is within a packet-data communication path of a device detecting, based on packet-data communicated on the path, presentation by the device of a particular type of media content. Further, the method involves the computing system responding to the detecting by triggering an attention-monitoring process that monitors whether a person is viewing the presented media content.

In another respect, disclosed is another method for triggering an attention-monitoring process. This method involves a device detecting, based on information from an accessibility service of the device, presentation by the device of a particular type of media content. Further, the method then involves the device responding to the detecting by triggering an attention-monitoring process that monitors whether a person is viewing the presented media content.

As noted above, the act of detecting presentation by the device of a particular type of media content could involve detecting presentation by the device of an advertisement as opposed to a program or other type of non-advertisement content. Further the act of triggering the attention-monitoring process could involve causing the device to engage in the attention-monitoring process, among other possibilities.

In yet another respect, disclosed is a computing system including at least one processor, non-transitory data storage, and program instructions stored in the non-transitory data storage and executable by the at least one processor to cause a computing system to carry out operations such as those of the above methods for instance.

In still another respect, disclosed is non-transitory computer-readable data storage, having stored thereon program instructions executable by at least one processor of a computing system to carry out operations such as those of the above methods for instance.

In yet a further respect, disclosed is a computer program comprising program instructions executable by at least one processor of a computing system to perform operations such as those of the above methods for instance.

These, as well as other embodiments, aspects, advantages, and alternatives, will become apparent to those of ordinary skill in the art by reading the following detailed description, with reference where appropriate to the accompanying drawings. Further, it should be understood that the disclosure provided in this summary and elsewhere in this document is provided by way of example only and that numerous variations and other examples may be possible as well.

### BRIEF DESCRIPTION OF THE DRAWINGS

FIG. 1 a simplified block diagram of a media-presentation device.

FIG. 2 is a simplified block diagram illustrating placement of an on-device meter in an example media-presentation device.

FIG. 3 is a flow chart illustrating an example method.

FIG. 4 is a simplified illustration of a display with UI components related to advertisement presentation.

FIG. 5 is a flow chart illustrating another example method.

### DETAILED DESCRIPTION

The present disclosure will discuss example implementation in terms of mechanisms for detecting that a device is presenting an advertisement and for responding to the detecting by triggering an attention-monitoring process. However, as noted above, the disclosed principles could take other forms as well, involving detecting presentation of any of various particular types of content and responsively taking any of a variety of actions.

More generally, it will be understood that arrangements and processes disclosed herein could take various other forms. For instance, elements and operations could be re-ordered, distributed, replicated, combined, omitted, added, or otherwise modified. Further, elements described as functional entities could be implemented as discrete or distributed components or in conjunction with other components/modules, and in any suitable combination and location. Still further, various operations described as being carried out by one or more entities could be implemented by and/or on behalf of those entities, through hardware, firmware, and/or software, such as by one or more processing units executing program instructions stored in memory, among other possibilities.

### Example Attention-Monitoring

An attention-monitoring process that could be triggered by the disclosed mechanisms could take any of various forms.

In general, the attention-monitoring process may operate to determine whether a person is attentive to media content being presented by the device, i.e., whether a person is attentive to the media content presentation. For instance, to the extent applicable, the attention-monitoring process may operate to determine whether a person is viewing the content presentation and/or to determine whether a person is listening to the content presentation.

Determining that a person is attentive to the content presentation may prove useful in various ways. For instance, a computing system may use such a determination as a basis to control reporting of associated signature data to an audience-measurement platform, such as by triggering reporting just to times when a person was attentive to the content presentation. Further, a computing system may use such a determination as a basis to control aspects of the content presentation itself, such as to adjust display brightness, audio output level, and/or other presentation characteristics on grounds that a person is currently attentive to the presentation. Still further, a computing system may use such a determination as a basis for educational tracking, such as to confirm whether a person is actually watching and/or listening to an educational presentation for instance.

A rudimentary example of an attention-monitoring process involves presenting a prompt to request user input indicating whether a person is attentive to the content presentation, and, in response to presenting the prompt, receiving the requested user input. For instance, a computing system may present such a prompt as a visual overlay on a display of the device and/or as an audio prompt or other type of prompt, and may receive the requested user input through remote-control signaling (e.g., by a user pressing appropriate buttons on a handheld remote control) or through microphone input (e.g., by a user speaking a response and a speech-recognition engine recognizing the response), among other possibilities.

Another example of an attention-monitoring process, with respect to visual content presentation, is attention monitoring based on gaze estimation, as described for instance in International Patent Application No. PCT/US2024/052364 (the ’364 application), filed October 22, 2024, the entirety of which is hereby incorporated by reference.

As discussed in the ’364 application, attention monitoring by gaze estimation could involve using a trained machine-learning model to predict whether a person is attentive to visual media content, with the machine-learning model having been trained based on geometric data associated with head pose and facial landmarks in correlation with levels of attentiveness. For instance, a camera collocated with the visual media content (e.g., coplanar with a display presenting the content) may capture an image of the person’s head including the person’s face, the computing system may obtain certain geometric attributes from the captured image, and the computing system may provide the geographic attributes to the trained machine-learning model and receive as output from the model a prediction of whether the person is attentive to the visual media content. Further, the computing system may repeat this process over time as a basis to monitor when and to what extent the person is attentive.

Other forms of attention-monitoring processes could be possible as well.

### Use of Real-Time Packet Traffic as Basis to Trigger Attention Monitoring and/or other Action

One way to trigger attention monitoring or other action is by detecting within packet-data communication to or from the media-presentation device an indication of communication of an advertisement to the device. Namely, a meter or other computing system that has a view of packet-data communication to and/or from the device may detect packet-data signaling indicating communication of an advertisement to the device, which may support a reasonable conclusion that the device is presenting (e.g., is currently presenting or is about to present) the advertisement.

By way of example, if the packet-data communication carries or is otherwise accompanied by metadata indicating that an advertisement is being provided to the device, the computing system could detect presence of that metadata and could determine, based on the detected metadata, that the device is receiving an advertisement.

For instance, if a web browser application running on the device downloads from a web server a Hypertext Markup Language (HTML) document defining a web page to be rendered by the device, and if the HTML document includes an HTML tag that points to an advertisement media object (e.g., image or video file) for the browser to download or otherwise acquire and render as part of the web page, that HTML tag may include an indication that that media object is an advertisement. By way of example, if the HTML tag includes a Universal Resource Locator (URL) defining a file location of the media object at a network server, that URL may include a query parameter that indicates that the media object is an advertisement (e.g., “?TYPE=Ad”), and/or the server name in the URL may inherently suggest (e.g., correlate with) serving of an advertisement. Alternatively, the HTML document may otherwise indicate that the media object that will be included in the rendered web page is an advertisement.

In response to that HTML, the web browser may then generate and the device may transmit an HTTP GET request seeking to obtain that media object for the web browser to render as part of the web page. Further, the web browser may include in this HTTP GET request the provided indication that the media object is an advertisement, or another indication that the media object is an advertisement. For instance, the web browser may include in the GET request the URL that has the query parameter indicating that the media object is an advertisement. Alternatively, based on the browser determining from the HTML document, or in another manner, that the media object is an advertisement, the browser may otherwise include in or with the GET request an indication that the media object is an advertisement.

As this GET request passes through the computing system, the computing system may then read the GET request and detect in the GET request the indication that the requested media object is an advertisement. Based on this indication, the computing system may then take, or otherwise cause the device to take, responsive action. For instance, the computing system may responsively call a program module on the device that will engage in attention monitoring for a period of time, which may help to determine whether a person is looking at the presentation of the web page and thus possibly at the presented advertisement.

Alternatively or additionally, when the device sends the GET request and/or another form of request for the media object, a server that receives that request may respond by transmitting to the device the media object along with an indication that the provided media object is an advertisement. For instance, the server may include as metadata with the media object an indication that the media object is an advertisement.

As this transmission passes through the computing system, the computing system may then likewise read this indication and thereby determine that the media object being acquired by the device is an advertisement. Then similarly, based on this determination, the computing system may responsively take, or otherwise cause the device to take, action – such as by calling the program module as noted above, among other possibilities.

The computing system in this arrangement could be largely any computing system that has a view of packet-data traffic to and/or from the media-presentation device, namely, packet-data traffic that may indicate an advertisement being provided to the device.

Such a computing system may be provided generally to facilitate metering and reporting to an audience-measurement company. For instance, the computing system may be configured generally to monitor packet-data traffic to and/or from the device, to detect communication events based on that traffic, and to report those detected events to a back-end (e.g., cloud-based) system operated by the audience-measurement company. The back-end system may then factor those reported events into its process of establishing media-exposure data and its related analysis.

Example events that such a computing system may detect and report to the back-end system may include domain events and bandwidth events, among other possibilities.

Domain events may include occurrences of the device communicating with a particular network server (e.g., a particular domain name) – which may establish that the device is receiving media content from that server, as a useful data point for media-exposure analysis. For instance, the computing system may detect Domain Name Service (DNS) signaling to and/or from the device, which may establish a server name (e.g., domain name) with which the device is communicating. Further, the computing system may detect other signaling, such as Hypertext Transfer Protocol (HTTP) or other-protocol signaling with a particular server (e.g., per IP address and/or server name), also establishing that the device is communicating with that server, also as a useful data point for media-exposure analysis.

Bandwidth events, on the other hand, may include occurrences of the device receiving packet data communication having a pattern of flow that may suggest particular communication activity. For instance, a bandwidth event may be an occurrence of the device receiving from a given server a packet-data flow that has a pattern of streaming, such as recurring instances of high-enough bit-rate communication typical of streaming-media (e.g., streaming video) communication. This sort of bandwidth event may usefully establish, or at least support a reasonable conclusion, that the device was receiving streaming media at the time of the event, which may also be a useful data point for media-exposure analysis.

In an example implementation, the computing system could be provided in the device itself, such as with program instructions executable by a processor in the device to carry out the computing system operations, and the computing system and/or other logic in the device could engage in the attention-monitoring process in response to the computing system detecting that the device is presenting an advertisement. For instance, the computing system could be an on-device meter (ODM) in the device. Without limitation, an example of such an ODM could be as described in U.S. Provisional Patent Application No. 63/740,781, filed December 31, 2024, the entirety of which is hereby incorporated by reference.

An ODM could be defined by program logic executed by a processor of the device, to monitor packet-data communication by the device. Further, the ODM could be situated logically between an operating system of the device and a communication interface of the device, among other possible arrangements, so as to have a view of packets that the operating system provides to the communication interface for transmission from the device and packets that the communication device receives and passes along to the operating system for processing.

As a specific example, the ODM could be configured to operate as an on-device virtual-private-network (VPN) server, and the device could be configured to operate a VPN client that is set to use that VPN server, so that packet-data communication to and/or from the device would pass through the on-device VPN server and thus through the ODM, thereby giving the ODM a view of the device’s packet-data traffic.

As presently contemplated, this or another such ODM may be configured to monitor for the presence in the packet-data communication of an indication of an advertisement being provided to the device, as a basis to trigger an attention-monitoring process.

For instance, the ODM may be configured to monitor packet-data communication by the device and, as noted above, and to detect in the packet-data communication an indication of the device requesting an advertisement media object and/or of an advertisement media object being provided to the device. Once the ODM detects this indication, the ODM could then responsively trigger an attention-monitoring process, such as by calling associated program logic that is part of the ODM or otherwise part of the device, or by calling external program logic, that would responsively engage in the attention-monitoring process.

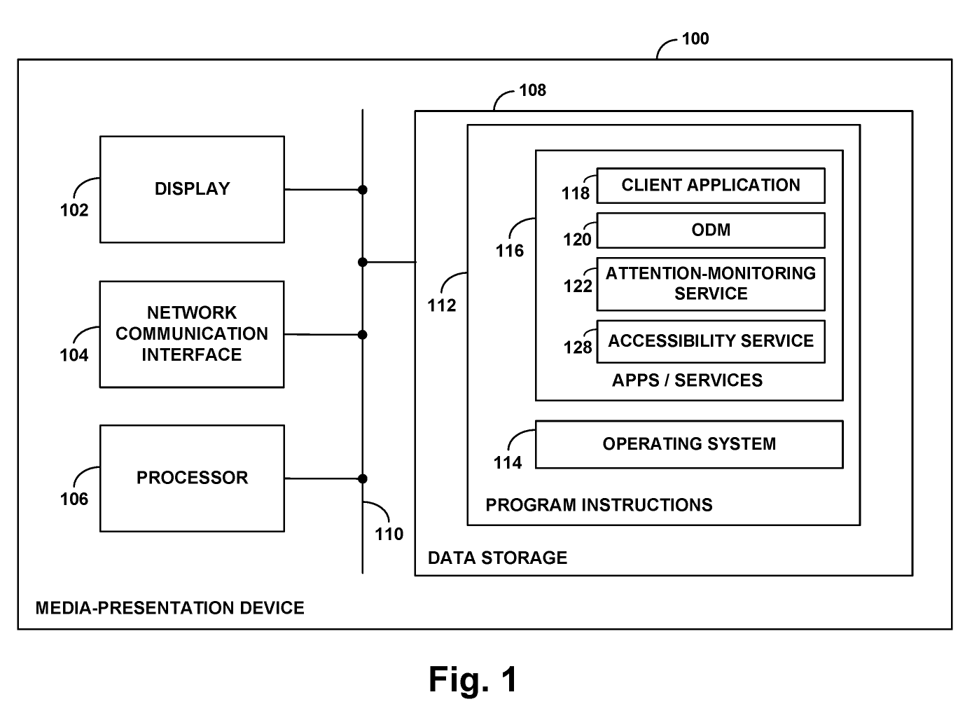

FIG. 1 is a simplified block diagram of a media-presentation device 100, showing some of the components that such a device may include to facilitate carrying out this and other processes. As shown in FIG. 1, the includes a display 102, a network communication interface 104, a processor 106, and non-transitory data storage 108, which may be integrated together in various ways and/or interconnected by a system bus or other connection mechanism 110, among other possibilities.

The display 102, with an associated display-rendering engine (not shown), could function to display visual content. Examples types of displays include, without limitation liquid crystal display (LCD) and organic light emitting diode (OLED) display.

The network communication interface 104 could may comprise one or more wired and/or wireless network communication modules along with associated drivers and/or other logic, to enable communication over a network. For instance, the network communication interface 104 may include a wired and/or wireless Ethernet adapter along with associated program logic.

The processor 106 may comprise one or more general purpose processors (e.g., microprocessors) and/or one or more specialized processors (e.g., digital signal processors (DSPs), graphics processing units (GPUs), neural processing units (NPUs), etc.) Further, the non-transitory data storage 108 may comprise one or more volatile and/or non-volatile storage components (e.g., flash, optical, magnetic, read only memory (ROM), random access memory (RAM) (e.g., dynamic RAM (DRAM), static RAM (SRAM), or double data rate RAM (DDRAM)), electronically programmable read only memory (EPROM), and/or electronically erasable programmable read only memory (EEPROM), etc.), which may be integrated in whole or in part with the processor 106.

As further shown, the non-transitory data storage 108 could store program instructions 112, which may be executable by the processor 106 to carry out (i.e., cause the device to carry out) various operations described herein. As shown in FIG. 1, these program instructions 112 could include an operating system 114 of the device 100, as well as numerous applications and services 116 running on or as part of the operating system 114. As shown, example applications and services 116 may include a client application 118, an ODM 120, and an attention-monitoring service 122.

The client application 118 may be an application that may engage in data communication with a remote entity via the network communication interface 104 and a packet-switched network such as the internet. The ODM 120 may function to monitor packet-data communication by the device 100, to detect based on the packet-data communication that the device is receiving an advertisement, and to responsively trigger application of the attention-monitoring service 122. And the attention-monitoring service 122, which may be implemented by the ODM 120 and/or the operating system 114, among other possibilities, may operate as described above or in other ways, to monitor whether a person is attentive to media content presentation of the device 100, such as whether the person is looking at the display 102 for instance.

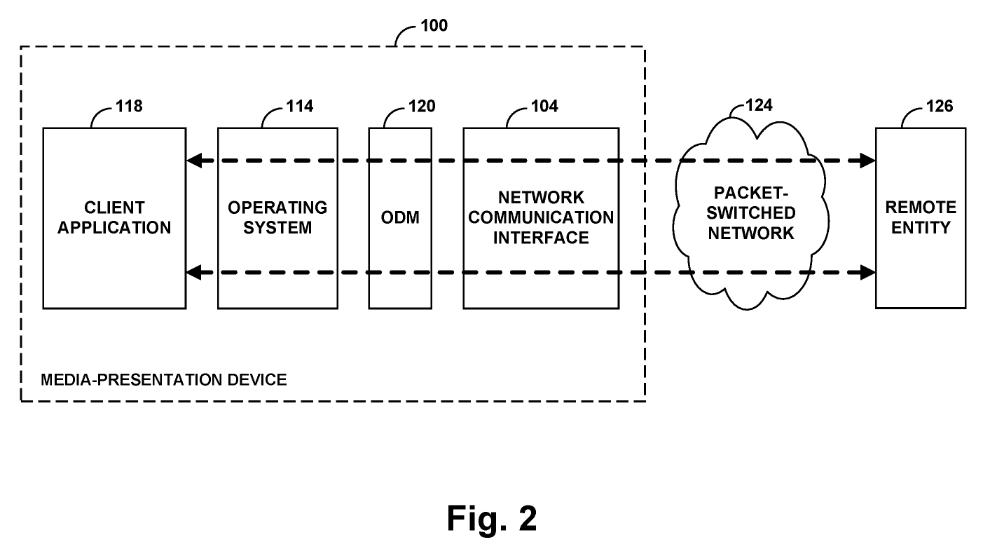

FIG. 2 illustrates how the ODM 120 could operate in this example arrangement to monitor packet-data communication by the device 100 and, upon thereby detecting that the device 100 is receiving an advertisement, to trigger application of the attention-monitoring service 122.

In particular, FIG. 2 shows the ODM 120 operating logically as an intermediary between the operating system 114 and the network communication interface 104 of the device 100. Further, the figure illustrates that the device 100 may have network connectivity with a packet-switched network 124, so that the device 100 can engage in packet-data communication with a remote entity 126.

With this arrangement, when the client application 118 has data to send to the remote entity 126, the client application 118 may provide the data to the operating system 114, and the operating system 114 may process the data through a protocol stack to produce Internet Protocol (IP) packets containing the data and may provide the IP packets to the network communication interface 104 for physical transmission over the packet-switched network 124 to the remote entity 126. Likewise, when the network communication interface 104 receives IP packets carrying data destined to the client application 118, those packets may pass to the operating system 114, and the operating system 114 may extract the data from the packets and pass the data along to the client application 118.

With ODM 120 situated between the operating system 114 and the network communication interface 104, the ODM 120 could have a view of the packets that the device 100 transmits and receives. The ODM 120 could therefore read those packets and take associated action. In an example implementation, this can include the ODM 120 detecting in real-time based on packet-data communication to or from the device 100 that the device is receiving an advertisement, i.e., that data being received (e.g., currently being received or about to be received) by the device is an advertisement rather than, say, a program or other non-advertisement content.

By way of example, if the client application 118 is a web browser application and sends a GET request with a URL having a query parameter that indicates the browser is requesting an advertisement, or to an IP address or server name associated with providing advertisement content, the ODM 120 may detect based on that communication that the device 100 is obtaining an advertisement that would be rendered as part of a web page. Alternatively, or additionally, the ODM 120 may detect the device 100 receiving an advertisement by detecting inclusion of an advertisement object reference in a received HTML document and/or by detecting an advertisement indication accompanying a received media object, among other possibilities. In response to detecting that the device is receiving an advertisement in particular, the ODM 120 may then trigger attention-monitoring, such as by invoking (e.g., calling) the attention-monitoring service 122. The attention-monitoring service 122 may then responsively monitor whether a user of the device 100 is attentive to what is presented by the device, which may be the advertisement.

As another example, if the client application 118 is a streaming-media-player application and receives a real-time packet-based media stream with metadata (e.g., as packet-header data or as a watermark in the media, among other possibilities) indicating the presence of an advertisement, the ODM 120 may detect based on that metadata that the device 100 is receiving an advertisement. Alternatively, if the streaming-media-player application sends a streaming media request to an address or server name associated with providing advertisement content (e.g., an advertisement server), the ODM 120 may detect based on that IP address or server name that the device is receiving an advertisement. Here too, in response to detecting that the device is receiving an advertisement, the ODM 120 may then trigger attention-monitoring, such as by invoking the attention-monitoring service 122, and the attention-monitoring service 122 may then responsively monitor for user attentiveness.

In an alternative implementation, the computing system that detects that the device 100 is receiving an advertisement and that responsively invokes attention monitoring could be external to the device 100. For instance, if the device 100 is connected with a local area network (LAN), a meter or other computing system situated on the LAN (e.g., in or as a LAN router or gateway) and/or otherwise configured to have a view of packet-data traffic to and/or from the device 100 could similarly monitor that packet-data traffic to detect when the device 100 is receiving an advertisement. Responsive to detecting the device 100 receiving an advertisement, the computing system could then transmit over the LAN to the device 100 a control message to which the device 100 could be configured to respond by invoking the attention-monitoring service 122. Other arrangements are possible as well.

Note also that the process of detecting that a media-presentation device is receiving an advertisement (e.g., is currently receiving the advertisement or is about to receive the advertisement) may implicitly amount to detecting that the media-presentation device is presenting an advertisement (e.g., is currently presenting the advertisement or is about to present the advertisement), on grounds that the recipient device is a media-presentation device.

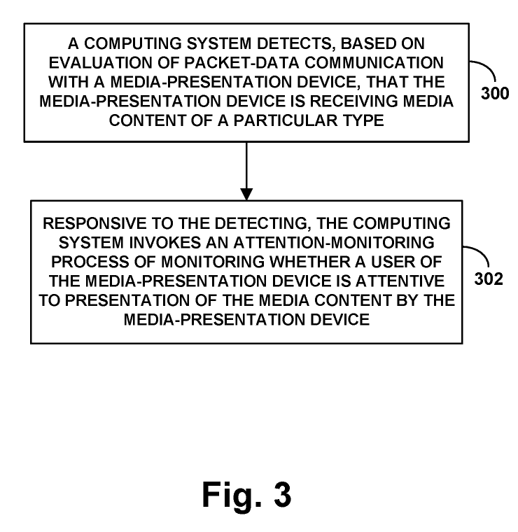

FIG. 3 is a flow chart illustrating an example method that could be carried out by a computing system, to use real-time packet-data communication as a basis to trigger attention monitoring. As shown in FIG. 3, at block 300, the method includes a computing system detecting, based on evaluation of packet-data communication with a media-presentation device, that the media-presentation device is receiving media content of a particular type. And at block 302, the method includes, responsive to the detecting, the computing system invoking an attention-monitoring process of monitoring whether a user of the media-presentation device is attentive to presentation of the media content by the media-presentation device.

In line with the discussion above, the detecting that the media-presentation device is receiving media content of the particular type could involve detecting that the media-presentation device is receiving advertisement content. Further, this could involve detecting communication from the media-presentation device of packet data carrying a request for advertisement content and/or detecting communication to the media-presentation device of packet data carrying an indication of advertisement content.

In addition, as discussed above, the computing system that carries out this method could be within the media-presentation device, as an ODM for instance, or could be external to the media-presentation device. Further, the attention-monitoring process could be carried out by the media-presentation device.

As noted above, this method could also be used to trigger action other than or in addition to attention-monitoring. For instance, the method could be used to trigger adjustment of content-presentation volume and/or dynamic revision of presented content, among other possibilities.

### Use of Accessibility Service as Basis to Trigger Attention Monitoring and/or other Action

In addition, or alternatively, the ODM 120 or other logic defined in an example media-presentation device could make use of an accessibility service running on the media-presentation device as a basis to determine when the device is presenting an advertisement or another specific type of content for instance, so as to trigger responsive action such as attention monitoring. FIG. 1 illustrates an accessibility service 128 as additional program instructions on the device 100, e.g., executable by the processor 106 of the device 100.

The accessibility service 128 when running on the device 100 may normally enable the device 100 to describe to a user of the device what content is presented on a display of the device. For instance, when the device 100 presents on its display 102 a graphical arrangement of user-interface elements, the accessibility service 128 may be set to audibly tell a user of the device what user interface (UI) elements are presented, including perhaps where the UI elements are positioned on the display 102. The accessibility service 128 may be able to determine this information through interaction with a display-rendering engine or other logic on the device, among other possibilities, obtaining a data structure (e.g., a tree-like structure) that represents what UI elements are currently displayed.

In an example implementation, the ODM 120 in such a device may usefully subscribe to be notified by the accessibility service 128 of what content is presented by the device 100, possibly specifically what content is presented by particular applications on the device 100, including what UI elements are presented. For instance, the operating system 114 may define an application-programming-interface (API) through which the ODM 120 may so subscribe to the accessibility service 128.

Pursuant to this subscription, the ODM 120 may then receive associated notifications from the accessibility service 128. And based on one or more such accessibility-service notifications, the ODM 120 may detect that the device 100 is presenting an advertisement. In response to thereby detecting that the device 100 is presenting an advertisement, the ODM 120 may then invoke the attention-monitoring service 122 as noted above.

To help avoid overburdening the processor 106 with accessibility notifications, the ODM 120 may limit this sort of subscription to be with respect to just one or more applications on the device that could present an advertisement. For instance, this may include applications that present visual content, such as a streaming-video player application, a gaming application, or a web browser, among other examples. To facilitate this, the computing system may include in it's subscribe request to the accessibility service a designation of one or more applications or classes of application to be subject to the subscription. The accessibility service 128 may then keep the ODM 120 apprised of what UI components are presented by each such application, so that the ODM 120 can monitor for advertisement presentation.

Using the accessibility service 128 as a basis to detect when the device 100 is presenting an a particular type of content may hinge on certain UI elements or combinations of UI elements being typical when the device 100 is presenting that type of content. For instance, certain UI elements that would be presented by particular applications may suggest the presentation of an advertisement.

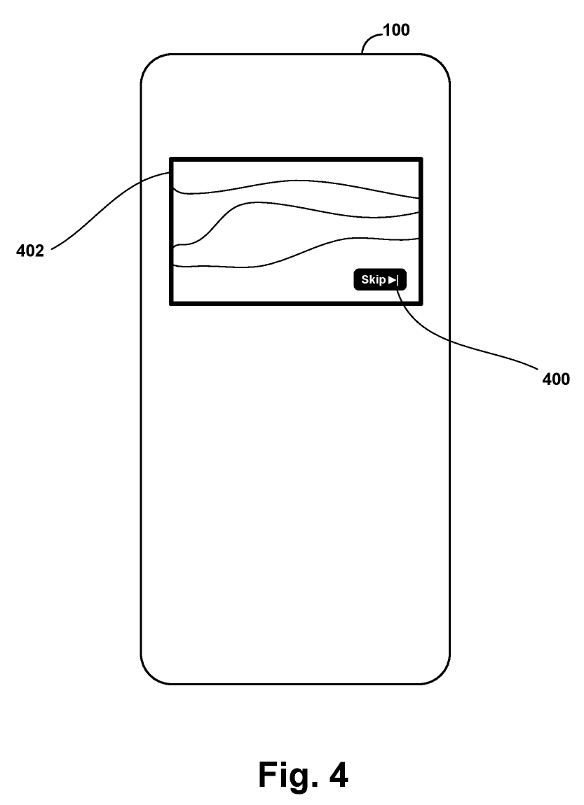

By way of example, a video-streaming service may be structured to stream advertisement videos as commercial breaks before or during streaming of main (e.g., requested) video content and to include as an overlay on such advertisement videos a “SKIP” button that a viewer of the videos could engage in order to skip presentation of the advertisement. FIG. 4 shows an example of such a display. Thus, when the device 100 is presenting a UI component that is a button 400 with the label “SKIP,” possibly specifically when that button is provided as an overlay within a video frame UI element 402, that may support a reasonable conclusion that the device 100 is presenting an advertisement.

With this example, the ODM 120 may programmatically subscribe to the accessibility service 128 to be notified of what UI elements are presented by one or more applications that could present video, which may include a video player application, a web browser application, a gaming application, and/or one or more other such applications.

Thus, based on that subscription, when such an application presents video content on the display of the device, the accessibility service 128 may notify the ODM 120 what UI elements are presented as various UI elements are presented. These UI elements may include frame elements, a video, and, as an overlay on the video (e.g., nested within a video frame element), a button labeled “SKIP”. In response to receiving this accessibility-service notification, the ODM may thus determine, based on the notified presence of the video and the overlay “SKIP” button, that the device 100 is currently playing an advertisement video. And in response to this determination, the ODM 120 may responsively invoking the attention-monitoring service 122 and/or take other action.

Other accessibility-service notifications, not limited to a SKIP-button overlay may be possible as well. In particular, notification by the accessibility service 128 of any UI components that are deemed to correlate with presentation of an advertisement may serve as a basis for the ODM 120 to determine that the device is presenting an advertisement, so as to trigger action such as invoking the attention-monitoring service 122 for instance. Other example UI components may include, for instance, (i) an overlay on a video of the word “Ad” possibly followed by a countdown timer, and (ii) other graphic overlays or other graphics or media objects that are suggestive of presentation of an advertisement.

Further, accessibility-service notifications may provide the ODM 120 with a sequence of information that cooperatively suggests presentation of an advertisement. Thus, based on such a sequence, the ODM 120 may detect that the device 100 is presenting an advertisement, and the ODM 120 may responsively invoke the attention-monitoring service 122.

Use of accessibility-service notifications may also enable the device 100 to discontinue taking an action when appropriate. For instance, if the ODM 120 invokes an attention-monitoring process in response to an accessibility-service notification that the device 100 is displaying one or more components suggestive of presentation of an advertisement, the ODM 120 may also discontinue the attention-monitoring process in response to an accessibility-service notification that the device is no longer displaying such component(s) or based on other associated logic.

By way of example, if the accessibility service 128 had notified the ODM 120 that a “SKIP” button was presented as an overlay on a video, thus causing the ODM 120 to invoke the attention-monitoring process, the accessibility service 128 may thereafter notify the ODM that that “SKIP” button is no longer presented (or perhaps that other content is presented in place of the “SKIP” button), and the ODM 120 may respond to that further notification by signaling to the attention-monitoring service 122 to direct and thus cause the attention-monitoring service 122 to discontinue the attention-monitoring process.

As another example, if the accessibility service 128 had notified the ODM 120 that an Ad countdown timer was being displayed by the device 100 and had indicated a countdown timer value, the ODM 120 could responsively discontinue the attention-monitoring process upon expiration of that countdown timer. For instance, if the accessibility service 128 notifies the ODM 120 that the device 100 is presenting a countdown timer showing two minutes remaining, the ODM 120 may responsively call the attention-monitoring service 122 to start the attention-monitoring process and may also responsively itself start a timer for the indicated two minutes or for a similar time period. Upon expiration of that timer, the ODM 120 may then responsively direct and thus cause the attention-monitoring service 122 to stop the attention-monitoring process.

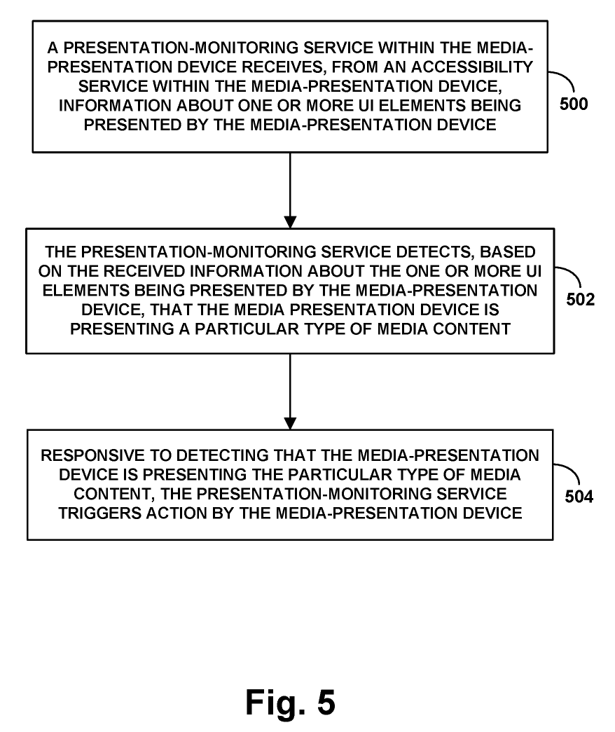

FIG. 5 is a flow chart illustrating an example method that could be carried out by a computing system, to use an accessibility service as a basis to detect when a particular type of content is presented and as a trigger to invoke attention monitoring or other action. As shown in FIG. 5, at block 500, the method includes receiving by a presentation-monitoring service within the media-presentation device, from an accessibility service within the media-presentation device, information about one or more UI elements being presented by the media-presentation device. Further, at block 502, the method includes detecting by the presentation-monitoring service, based on the received information about the one or more UI elements being presented by the media-presentation device, that the media presentation device is presenting a particular type of media content. At block 504, the method then includes, responsive to detecting that the media-presentation device is presenting the particular type of media content, the presentation-monitoring service triggering action by the media-presentation device.

In line with the discussion above, the presentation-monitoring service in this method could be an ODM or other program logic running in the media presentation device. Further, the particular type of media content could be advertisement content or another type of media content. And the action that gets triggered based detecting that the media-presentation device is presenting advertisement content could be attention-monitoring, namely, monitoring whether a user of the media-presentation device is attentive to media content presentation by the media-presentation device, or another action.

The present disclosure also contemplates non-transitory data storage (e.g., one or more non-transitory computer-readable medium components (e.g., flash, optical, magnetic, ROM, RAM) (e.g., DRAM, SRAM, or DDRAM), EPROM, and/or EEPROM, and/or other computer-readable media, etc.)) holding program instructions executable by at least one processor of a device to cause a computing system to carry out various operations described herein, such as those of the example methods of FIGS. 3 and 5 for instance.

Further, the present disclosure contemplates a computing system, comprising at least one processor, non-transitory data storage, and program instructions stored in the non-transitory data storage and executable by the at least one processor to cause the computing system to carry out operations described herein, such as those of the example methods for instance.

Further, the present disclosure contemplates a computer program comprising a set of program instructions executable by at least one processor of a computing system to carry out (e.g., to cause the computing system to carry out) various operations described herein, such as those of the example methods for instance. In an example implementation, the computer program could further be stored in non-transitory data storage such as that noted above, among other possibilities.

Exemplary embodiments have been described above. Those skilled in the art will understand, however, that changes and modifications may be made to these embodiments without departing from the true scope and spirit of the invention.

What is claimed is:

1. A computer-implemented method comprising:
detecting by a computing system, based on evaluation of packet-data communication with a media-presentation device, that the media-presentation device is receiving media content of a particular type; and
responsive to the detecting, invoking by the computing system an attention-monitoring process of monitoring whether a user of the media-presentation device is attentive to presentation of the media content by the media-presentation device.

2. The computer-implemented method of claim 1, wherein detecting that the media-presentation device is receiving media content of the particular type comprises detecting that the media-presentation device is receiving advertisement content.

3. The computer-implemented method of claim 2, wherein detecting based on evaluation of packet-data communication with the media-presentation device that the media-presentation device is receiving advertisement content comprises detecting communication from the media-presentation device of packet data carrying a request for advertisement content.

4. The computer-implemented method of claim 2, wherein detecting based on evaluation of packet-data communication with the media-presentation device that the media-presentation device is receiving advertisement content comprises detecting communication to the media-presentation device of packet data carrying metadata identifying advertisement content.

5. The computer-implemented method of claim 1, wherein the computing system is within the media-presentation device.

6. The computer-implemented method of claim 1, wherein the computing system is external to the media-presentation device.

7. The computer-implemented method of claim 1, wherein the attention-monitoring process is carried out by the media-presentation device.

8. A computing system comprising:
at least one processor;
non-transitory data storage; and
program instructions stored in the non-transitory data storage and executable by the processor to carry out operations including:
detecting, based on evaluation of packet-data communication with a media-presentation device, that the media-presentation device is receiving media content of a particular type, and
responsive to the detecting, invoking an attention-monitoring process of monitoring whether a user of the media-presentation device is attentive to presentation of the media content by the media-presentation device.

9. The computing system of claim 8, wherein detecting that the media-presentation device is receiving media content of the particular type comprises detecting that the media-presentation device is receiving advertisement content.

10. The computing system of claim 9, wherein detecting based on evaluation of packet-data communication with the media-presentation device that the media-presentation device is receiving advertisement content comprises detecting communication from the media-presentation device of packet data carrying a request for advertisement content.

11. The computing system of claim 9, wherein detecting based on evaluation of packet-data communication with the media-presentation device that the media-presentation device is receiving advertisement content comprises detecting communication to the media-presentation device of packet data carrying metadata identifying advertisement content.

12. The computing system of claim 8, wherein the computing system is within the media-presentation device.

13. The computing system of claim 8, wherein the computing system is external to the media-presentation device.

14. The computing system of claim 8, wherein the attention-monitoring process is carried out by the media-presentation device.

15. At least one non-transitory computer-readable medium having stored program instructions executable by at least one processor of a computing system to cause the computing system to carry out operations comprising:
detecting, based on evaluation of packet-data communication with a media-presentation device, that the media-presentation device is receiving media content of a particular type; and
responsive to the detecting, invoking an attention-monitoring process of monitoring whether a user of the media-presentation device is attentive to presentation of the media content by the media-presentation device.

16. The at least one non-transitory computer-readable medium of claim 15, wherein detecting that the media-presentation device is receiving media content of the particular type comprises detecting that the media-presentation device is receiving advertisement content.

17. The at least one non-transitory computer-readable medium of claim 16, wherein detecting based on evaluation of packet-data communication with the media-presentation device that the media-presentation device is receiving advertisement content comprises detecting communication from the media-presentation device of packet data carrying a request for advertisement content.

18. The at least one non-transitory computer-readable medium of claim 16, wherein detecting based on evaluation of packet-data communication with the media-presentation device that the media-presentation device is receiving advertisement content comprises detecting communication to the media-presentation device of packet data carrying metadata identifying advertisement content.

19. The at least one non-transitory computer-readable medium of claim 15, wherein the computing system is within the media-presentation device.

20. The at least one non-transitory computer-readable medium of claim 15, wherein the computing system is external to the media-presentation device.
